(19) United States
(12) Patent Application Publication
(10) Pub. No.: US 2026/0054200 A1
(43) Pub. Date: Feb. 26, 2026

(54) BOX BASIN WITH AN IMPROVED SEDIMENT TRAP

(71) Applicant: Seth N. Kenworthy, Battle Ground, WA (US)

(72) Inventor: Seth N. Kenworthy, Battle Ground, WA (US)

(21) Appl. No.: 18/811,613

(22) Filed: Aug. 21, 2024

(51) Int. Cl. B01D 21/00; B01D 21/02; B01D 21/24; E03F 5/14

(52) U.S. Cl. CPC B01D 21/0006; B01D 21/0042; B01D 21/02; B01D 21/2444; E03F 5/14

(57) ABSTRACT

An improved catch basin and related system for removing excess surface water. The improved basin includes a box like body having a plurality of sidewalls joined together at the corners. A floor is positioned at the bottom of the box and joined to the side walls. Opposite the floor is an upper opening having a frame. The frame is comprised of a ledge extending horizontally outward from the sidewall. A vertical barrier is joined to the distal free end of the ledge and extends upwardly therefrom. The ledge and retaining barrier are positioned and sized to receive a grate. The basin body is made of steel or a non-ferrous material. The basin further includes a sediment trap baffle within the box body. The sediment trap has a continuous wall protruding inward from the sidewall of the basin. The sediment trap baffle covers an outlet port formed through the sidewall during use. An optional collar extends the sidewall in the horizontal direction generally perpendicular to the sidewall. At least a portion of the sediment trap baffle can be repositioned during service of the connected plumbing.

### BACKGROUND OF THE INVENTION

### Field of the Invention

The present invention relates generally to commercial and residential surface water drainage systems, but more particularly to drainage basins used to catch and remove surface water via a subsurface piping system in fluid communication with the basin.

Drainage basins are used in both residential and commercial applications, including parking lots, around commercial buildings and homes, schools, and other structures or landscapes to remove groundwater and separate debris such as leaves, sticks, and trash in general from the water stream before it is expelled through a drainage pipe connected to a drainage basin.

The drainage pipe system used to carry the water away from the catch basin can be any size to fit the application. Three, four, and six-inch piping systems are the most common, but the present invention is not limited to any diameter outflow pipe enabling the basin to vary in size depending upon the application.

The size of the basin is selected depending upon the anticipated amount of water and debris in the groundwater runoff flowing into the basin body and how long the debris (e.g., leaves, sand, dirt, etc.) will remain in the basin body prior to clean out. Too much debris or floating obstructions, such as sticks, paper or plastic, and other yard waste, can clog a drainage basin outflow, causing the surface water to be removed to accumulate rather than be removed through the piping system. For example, commercial parking lot applications in heavily wooded areas may have a large basin body to catch and hold leaves and other debris for long periods of time. By comparison, residential dwelling applications may utilize a small, compact basin, because of the frequency of inspection and cleanout by the homeowner/caretaker.

Therefore, of paramount importance is the accessibility of the basin body and the outflow pipe for routine inspection, often with cameras to facilitate and clean out to prevent or minimize the possibility of clogging of the outflow pipe. Accordingly, the relevant background devices provide a sediment trap designed for trapping debris and sediment but are not designed to facilitate safe inspection and removal of obstructions with a repositionable sediment trap baffle.

### Description of the Background Art

The background drainage basin devices include steel basins like those manufactured by Gibson Steel Basins of Eugene, Oregon. The Gibson basin is comprised of a steel box-like body with a substantially rectangular horizontal cross-section formed by a continuous sidewall extending upward from a floor, a top opening spaced vertically spaced-apart from and substantially parallel with the floor; a fixed position sediment trap integral with the side wall; a frame extending upward from the sidewall forming the periphery of the top opening, wherein the frame further comprises a substantially horizontal ledge and a vertical barrier extending upwardly from and substantially perpendicular to the ledge; a removable grate operably positioned on the ledge and constrained by the vertical barrier; at least one outfall port formed through the sidewall, and a rigid collar surrounding the outfall port and extending horizontally outward from the sidewall for expelling water from the interior of the basin.

The background devices, including the Gibson-style basins, do not include a repositionable sediment trap to facilitate the cleanout and clearing of clogs in the connected effluent piping system. Unlike the background devices, the present invention has an improved sediment trap that is repositionable.

### SUMMARY OF THE INVENTION

The invention improves upon the background devices. A preferred embodiment of the present invention is an improvement over the Gibson-style steel basin. The preferred embodiments are made of steel. Alternate embodiments may be molded from a variety of non-ferrous materials, including polymers and plastics.

The invention can be summarized as a repositionable baffle designed for improved safety, inspection, reliability, and maintenance of a basin. The preferred embodiments of the present invention include removable and hinged baffles, as shown in the accompanying drawings.

The preferred embodiments may be summarized in a variety of ways including a box basin having a top opening for catching and removing surface water and trapping sediment, comprising: a body having an interior formed by a floor, a continuous sidewall extending upwardly from the floor, at least one outfall port formed through the sidewall for expelling water collected within the interior of the basin; a frame extending upward from the continuous sidewall forming the periphery of the top opening; a removable grate operably positioned on the ledge and constrained by the vertical barrier; and a sediment rap baffle having a continuous wall and a lid defining a lower passageway and at least one upper passageway in communication with an outfall port during use, wherein the baffle is repositionable from an operable and serviceable position.

The continuous sidewall includes baffle attachment means enabling the selective repositioning of the baffle in relation to the sidewall. The preferred baffle attachment means further comprises a hinge enabling the baffle to reciprocate between an operable and service position mode, or a plurality of baffle mounting rails with a substantially horizontal ledge to support the sediment trap baffle during use.

As an improvement over the background Gibson-style basin, the present invention may be summarized in a variety of ways, including: a basin for catching and removing surface water having a body with a substantially rectangular horizontal cross-section formed by a continuous sidewall extending upward from a floor, a top opening spaced vertically spaced apart from and substantially parallel with the floor; a frame extending upward from the sidewall forming the periphery of the top opening, wherein the frame further comprises a substantially horizontal ledge and a vertical barrier extending upwardly from and substantially perpendicular to the ledge; a removable grate operably positioned on the ledge and constrained by the vertical barrier; at least one outfall port formed through the sidewall, and a rigid collar surrounding the outfall port and extending horizontally outward from the sidewall for expelling water from the interior of the basin; wherein the improvement comprises a repositionable sediment trap baffle having a continuous wall and a lid defining a lower passageway and at least one upper passageway in communication with an outfall port during use.

Alternatively, the present invention can be summarized as an improved Gibson-style box basin with grate, wherein the improvement comprises a repositionable baffle having a continuous wall and a lid defining a lower passageway and at least one upper passageway in communication with an outfall port during use. The improvement further comprises baffle attachment means enabling the selective repositioning of the baffle in relation to the sidewall. The preferred embodiments of the baffle attachment means include a hinge pivotally interconnecting the sidewall and the baffle, enabling the baffle to reciprocate between an operable and serviceable position, or a plurality of baffle mounting rails and a substantially horizontal ledge to support the sediment trap baffle during use.

### BRIEF DESCRIPTION OF THE DRAWINGS

FIGS. 1 and 7 are top views of the preferred embodiment of the present invention shown with a portion of the removable grate cutaway.

FIGS. 2 and 8 are front plan views of the invention shown in FIG. 1.

FIGS. 3 and 9 are elevated perspective cross-sectional views of the invention taken along lines A of FIG. 1 and FIG. 7, respectively.

FIG. 4 is a top view of the basin of FIG. 1 shown installed and with the removable grate in place.

FIG. 5 is a side cross-sectional view of a preferred installation of the invention shown in operable relationship with an outfall pipe, rock bedding, expeller pipe, ground surface, rock backfill, earth backfill, and concrete slabs for positioning and optimized water flow.

FIG. 6 is a view of the preferred embodiment of the grate referenced in FIG. 1.

FIG. 7 is the top view of the inventive basin with an improved sediment trap.

FIG. 8 is a side view of the inventive basin.

FIG. 9 is a cross-sectional view taken along line A-A of FIG. 7.

FIG. 10 is a cross-sectional view taken along line B-B of FIG. 7.

FIG. 11 is an exploded view showing a portion of wall 14.

FIG. 12 is a side view of the wall shown in FIG. 11.

FIG. 13 is a top view of the sidewall shown in FIGS. 11-12.

FIGS. 14 and 15 show the removable baffle.

### DESCRIPTION OF THE INVENTION

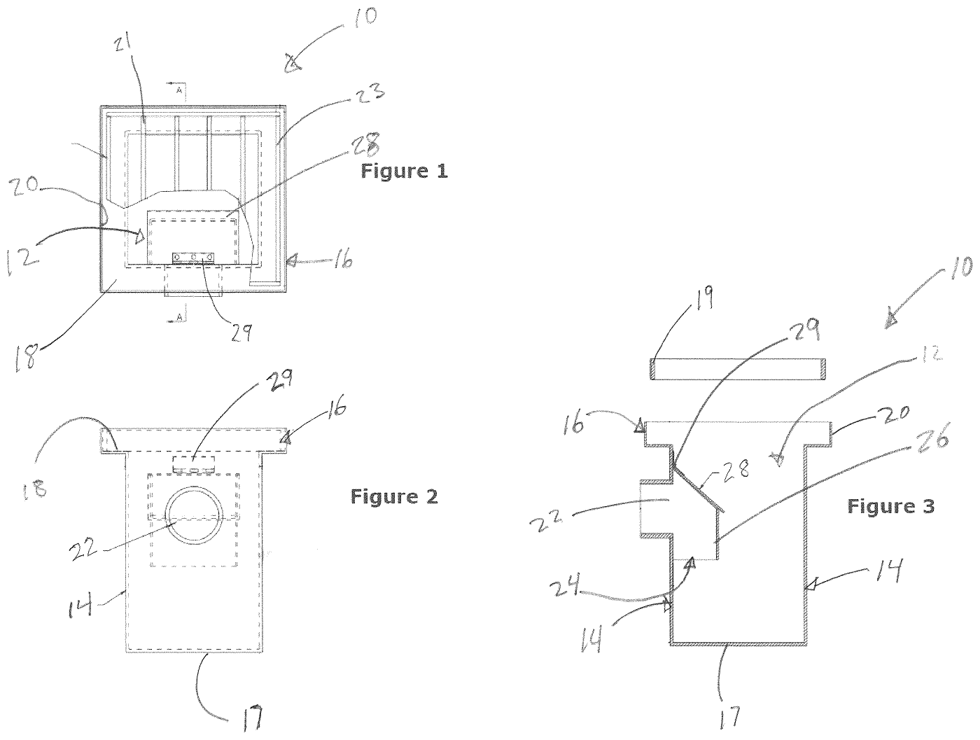

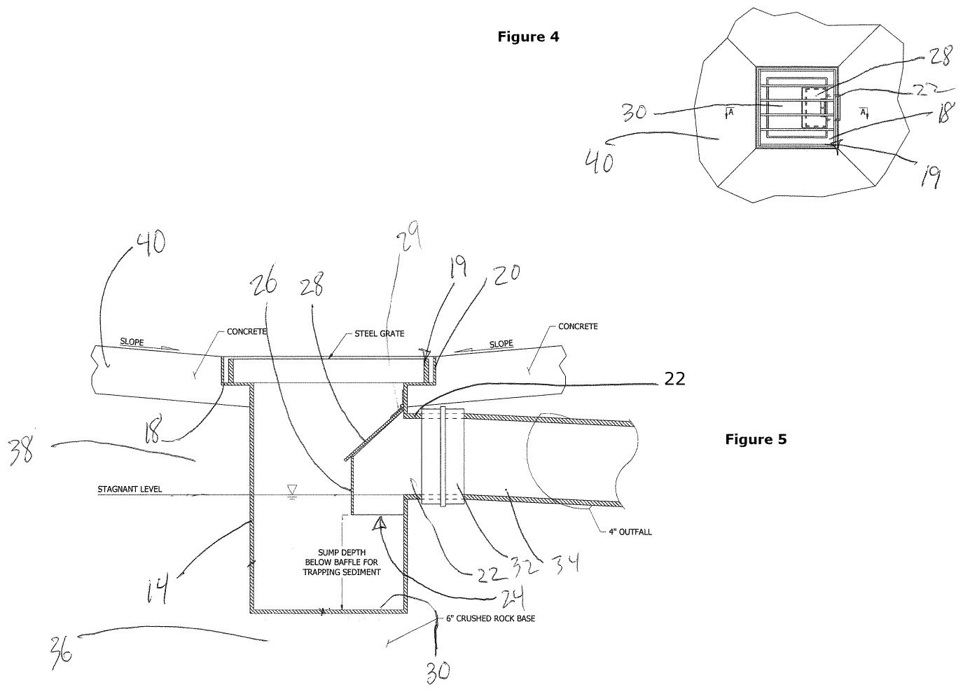

Regarding FIGS. 1-10, the inventive basin is generally designated by the reference numeral 10. Basin 10 resembles a box. The box body has an interior designated generally by the reference numeral 12, a plurality of sidewalls designated generally by the reference numeral 14, a ledge 18, and a basin opening designated generally by the reference numeral 16, and bottom 17. An outlet port 22 is formed through wall 14. An optional collar 21 is shown in communication with the sidewall 14 and outlet port 22.

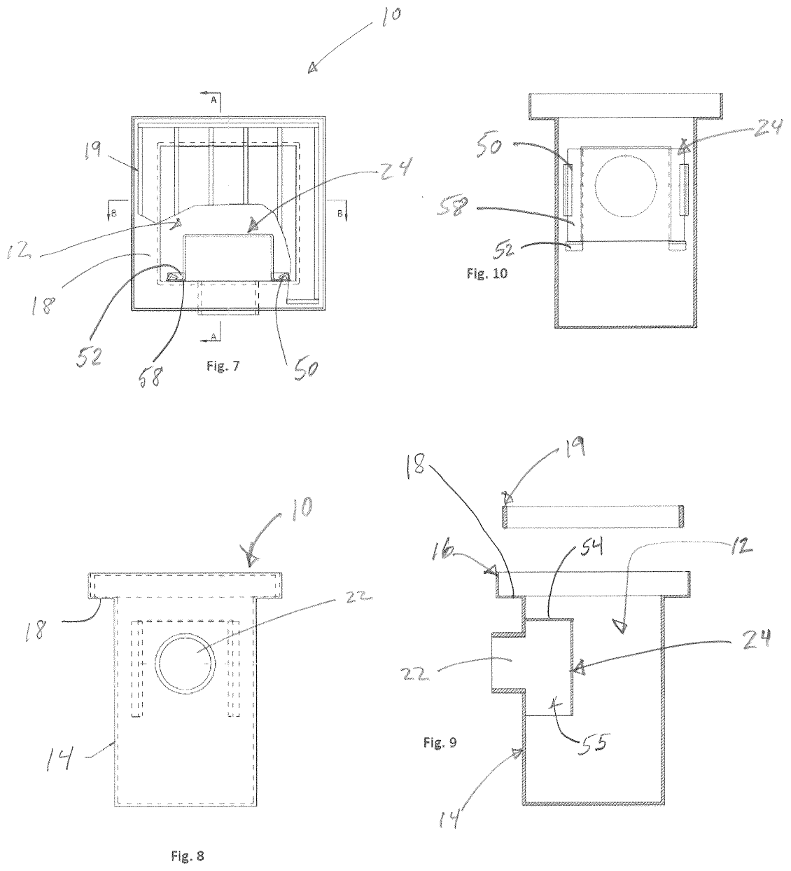

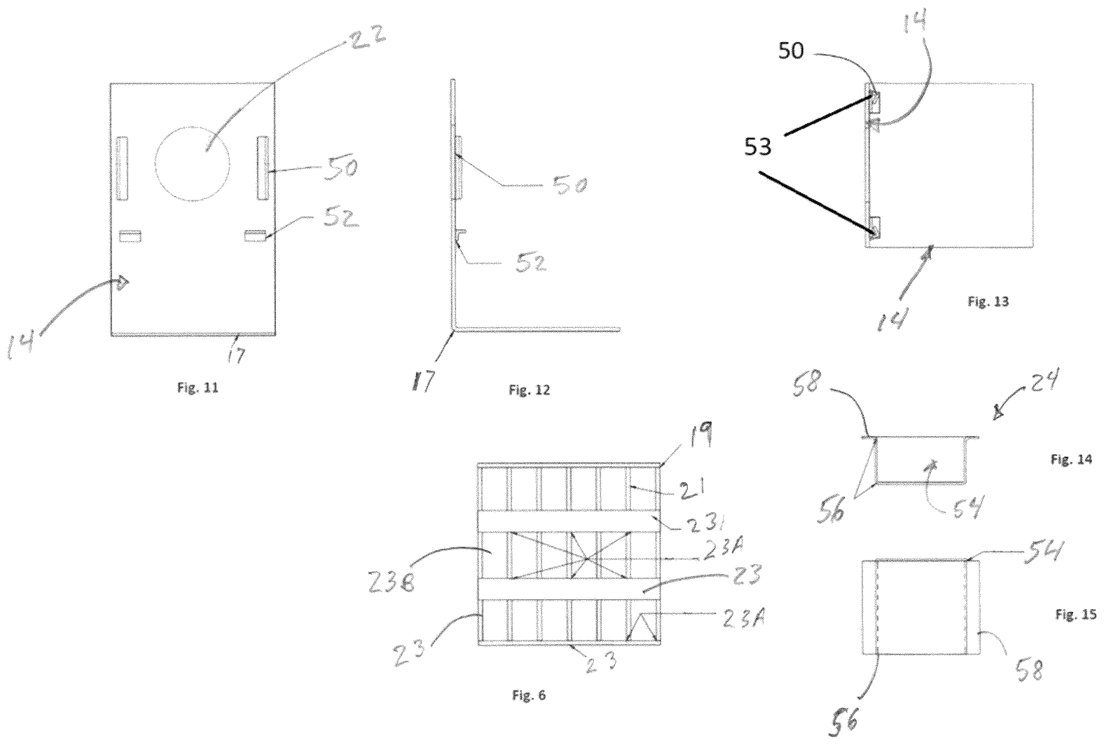

A removable grate, designated generally by the reference numeral 19 of FIGS. 1 and 6, rests on the ledge 18 during use. The preferred embodiment of grate 19 (FIG. 6) is comprised of a plurality of metal slats 21 and 23 welded together at junctions 23A to form a rectangle. Alternatively, sections of rebar may be substituted for some or all of the slats 21 of FIG. 6. Additional flats 23 are rigidly and orthogonally attached to slats (or rebar segments) 21 defining a plurality of apertures 23B through which water and debris may pass during use. The spacing of slats 21 and 23 is configured to minimize the likelihood of bicycle tires, stroller wheels, etc., from falling through the apertures 23B.

With reference to FIG. 3, a sediment trap “baffle” designated generally by the reference numeral 24 includes a vertical front wall 26 level with the centerline of port 22 when open. A means enabling the selective repositioning of at least a portion of the baffle in relation to the sidewall includes a hinged lid 28 (FIGS. 1-5) operably connected to the interior of the sidewall via hinge 29. The novel sediment trap with lid provides inspection and cleanout access to the outflow pipe via a gap sized between 2 and 3 times larger than other known basins.

With reference to FIG. 5, collar 21 is shown in communication with the outlet port 22 and a coupler 32 joining an external pipe 34 when in use as a system. A typical installation includes a bed of crushed rock supporting the floor 30 rests. Earth backfill 33 surrounds basin box 10 to hold it in place. A concrete slab 40 is positioned adjacent to sidewall 14 and frame 16 is sloped toward the basin. Surface groundwater flows naturally into the basin. Debris and other sediment caught in the flow washes into the basin and falls to the bottom. As the water level rises, the water column under sediment trap 24 is expelled through the outfall port 22 coupler 32 and pipe 34. Lighter material floats and sediments buildup in the bottom for collection and removal during service when the repositionable baffle is out of the way of the exit port.

With reference to FIGS. 7 through 10, the means enabling the selective repositioning of at least a portion of the baffle in relation to the sidewall also includes a removable baffle 24. In one preferred embodiment removable baffle 24 is secured to the interior 12 of the basin wall 14 in the. The wall includes baffle mounting rails 50 and stops 52 spaced apart from the outlet port 22.

The removable baffle designated generally by the reference numeral 24 rests on stop 52 during use (FIG. 10). In a preferred embodiment, removable baffle 54 includes a continuous sidewall and flanges 58.

With reference to FIGS. 10 through 15, the mounting rail 50 and stops 52 cooperatively engage flanges 58, enabling baffle 54 to be releasably secured (removable) with respect to the basin wall 14. More specifically, the rails 50 preferably comprise a length of angle steel having twin flat sections rigidly secured to the interior of the basin wall 14. One portion of the twin flat sections projects outwardly from the interior wall 14, and another portion of the flat section projects inwardly toward wall 14 (FIG. 13) to form a slot for removably receiving the sediment trap baffle flanges 58 and holding the sediment trap baffle 54 in close but communication with the sidewall 14 during use (the operable position), and further allowing removal of the baffle 54 from the basin in the safest service mode.

For example, during an inspection or clean-out, at least a portion of baffle 24 (or 54) having lid 28 is repositioned, exposing outlet 22 in service mode, rendering it accessible via camera, cleanout tools, hose nozzles, and other inspection or maintenance equipment inserted from the interior 12 of basin 10.

These and other embodiments are contemplated to be within the scope of the present invention whose only limitation is the claims set forth below. All such embodiments and equivalents, whether stated or not, are believed to be within the context of the present invention as claimed below.

What is claimed is:

1. A box basin having a top opening for catching and removing surface water and trapping sediment, comprising:
a body having an interior formed by a floor, a continuous sidewall extending upwardly from the floor, at least one outfall port formed through the sidewall for expelling water collected within the interior of the basin;
a frame extending upward from the continuous sidewall forming the periphery of the top opening;
a removable grate operably positioned on the ledge and constrained by the vertical barrier; and
a sediment rap baffle having a continuous wall and a lid defining a lower passageway and at least one upper passageway in communication with an outfall port during use, wherein;
the baffle is repositionable from an operable and serviceable position.

2. The basin of claim 1, wherein the continuous sidewall includes:
baffle attachment means enabling the selective repositioning of the baffle in relation to the sidewall.

3. The baffle attachment means of claim 2, comprises:
a hinge enabling the baffle to reciprocate between an operable and service position mode.

4. The baffle attachment means of claim 2, comprises:
a plurality of baffle mounting rails.

5. The frame of claim 4, further comprises:
a substantially horizontal ledge to support the sediment trap baffle during use.

6. The box basin of claim 1, wherein:
the body is made of steel.

7. The box basin of claim 1, wherein:
the body is made of a non-ferrous material.

8. A basin for catching and removing surface water having a body with a substantially rectangular horizontal cross-section formed by a continuous sidewall extending upward from a floor, a top opening spaced vertically spaced apart from and substantially parallel with the floor; a frame extending upward from the sidewall forming the periphery of the top opening, wherein the frame further comprises a substantially horizontal ledge and a vertical barrier extending upwardly from and substantially perpendicular to the ledge; a removable grate operably positioned on the ledge and constrained by the vertical barrier; at least one outfall port formed through the sidewall, and a rigid collar surrounding the outfall port and extending horizontally outward from the sidewall for expelling water from the interior of the basin; wherein the improvement comprises:
a repositionable sediment trap baffle having a continuous wall and a lid defining a lower passageway and at least one upper passageway in communication with an outfall port during use.

9. The basin of claim 8, wherein the continuous sidewall includes:
baffle attachment means enabling the selective repositioning of the baffle in relation to the outfall port and sidewall.

10. The baffle attachment means of claim 9, comprises:
a hinge enabling the baffle to reciprocate between an operable and serviceable position.

11. The baffle attachment means of claim 9, comprises:
a plurality of baffle mounting rails.

12. The frame of claim 11, further comprises:
a substantially horizontal ledge to support the sediment trap baffle during use.

13. The box basin of claim 8, wherein:
the body is made of steel.

14. The box basin of claim 8, wherein:
the body is made of a non-ferrous material.

15. An improved Gibson-style box basin with grate, wherein the improvement comprises:
a repositionable baffle having a continuous wall and a lid roof defining a lower passageway and at least one upper passageway in communication with an outfall port during use.

16. The improved Gibson-style basin of claim 15, wherein the improvement further comprises:
baffle attachment means enabling the selective repositioning of the baffle in relation to the sidewall.

17. The baffle attachment means of claim 16, comprises:
a hinge pivotally interconnecting the sidewall and the baffle, enabling the baffle to reciprocate between an operable and serviceable position.

18. The baffle attachment means of claim 16, comprises:
a plurality of baffle mounting rails, and
a substantially horizontal ledge to support the sediment trap baffle during use.

19. The box basin of claim 15, wherein:
the body is made of steel.

20. The box basin of claim 15, wherein:
the body is made of a non-ferrous material.
